(19) United States
(12) Patent Application Publication
(10) Pub. No.: US 2005/0248112 A1
(43) Pub. Date: Nov. 10, 2005

(54) Multi-component frame design

(75) Inventors: John Iavarone, Dana Point, CA (US); John Szalay, Corona Del Mar, CA (US)

Correspondence Address: STETINA BRUNDA GARRED & BRUCKER, 75 ENTERPRISE, SUITE 250, ALISO VIEJO, CA, 92656, US

(73) Assignee: THE BIKEBOARD COMPANY, LLC

(21) Appl. No.: 11/037,731

(22) Filed: Jan. 18, 2005

Related U.S. Application Data
(63) Continuation-in-part of application No. 29/205,028, filed on May 7, 2004.
(63) Continuation-in-part of application No. 29/208,130, filed on Jun. 24, 2004, now Pat. No. D507605.

(51) Int. Cl. B62M 1/00

(52) U.S. Cl. 280/87.041

(57) ABSTRACT

A multi-component frame design for use in constructing unique hybrid bicycle/skateboard vehicles. The frame is preferably fabricated from two sections that interconnect to form a complete frame member. Such frame member may be formed from three frame sections. The frame sections are preferably interconnected through tubular frame portions that telescope within complementary-fitting tubular frame portions. The frames are also preferably formed such that a skateboard truck is integrated within the end-most portion of the vehicle frame. The multi-component frame construction is particularly well-suited to facilitate the manufacture, shipping and assembly of BIKEBOARD™ brand of hybrid bicycle/skateboard vehicles.

### CROSS-REFERENCE TO RELATED APPLICATIONS

This application is a continuation-in-part of pending U.S. Design patent application Ser. No. 29/205,028, filed May 7, 2004 entitled FRAME DESIGN and pending U.S. Design patent application Ser. No. 29/208,130, filed Jun. 24, 2004 entitled FRAME DESIGN, the teachings of which are expressly incorporated by reference.

### STATEMENT RE: FEDERALLY SPONSORED RESEARCH/DEVELOPMENT

Not Applicable

### BACKGROUND OF THE INVENTION

Recently, a new type of hybrid bicycle and skateboard product has been introduced in the marketplace as an alternative to bicycles, skateboards, roller/inline skates and scooters. Such hybrid vehicle, produced by The Bikeboard Company, LLC of Santa Ana, Calif., is currently being sold under the trademark BIKEBOARD™, a trademark of The Bikeboard Company, LLC. Such vehicles are characterized by a unique L-shaped frame that defines front, intermediate and end portions. The front end of the frame has a bicycle-type head tube through which upwardly extends a stem with conventional bicycle handlebars, and a fork extending downwardly therefrom. A conventional front bicycle tire is affixed to the fork per conventional bicycle construction. A down tube portion extends from the head tube in an angled direction and is thereafter provided with a bend, with the remaining frame portion extending rearwardly therefrom, upon which is mounted a conventional skateboard deck. The skateboard deck and/or the rearmost portion of the frame is attached either a skateboard truck or support post having a pair of skateboard wheels attached thereto. When the BIKEBOARD™ vehicle assumes an upright position, the rearmost portion of the frame remains in generally parallel relation to the ground.

Such frame design is depicted in pending U.S. Design patent application Ser. No. 29/205,028, filed May 7, 2004 entitled FRAME DESIGN and U.S. pending Design patent application Ser. No. 29/208,130, filed Jun. 24, 2004 entitled FRAME DESIGN, the teachings of which are expressly incorporated herein by reference.

Such hybrid scooter product has been met with great consumer enthusiasm despite only recently being made commercially available. In this respect, the BIKEBOARD™ product is in many respects easier to ride and safer to utilize compared with bicycles and skateboards. Additionally, because of the front bicycle wheel configuration, the BIKEBOARD™ products are provided with a front hand brake to facilitate the ability of the rider to stop the product, which is much safer and reliable compared to conventional scooters that typically have a rear foot-activated brake that requires the rider to maintain his or her balance while applying the brake mechanism. Further advantages of such product include its durability; omission of any type of gears, sprockets, chain or pedal components; steering capability; and the ability to be readily used by both adults and small children. In this regard, and in contrast to bicycles and skateboards, certain models of the BIKEBOARD™, and in particular a line sold as TIKEBOARD™, are specifically designed and configured for use by small children ages four and up.

Despite its numerous advantages, certain problems have been identified with respect to the manufacture and construction of the hybrid bicycle/skateboard products referenced herein. In this respect, the finalized product, when fully constructed, extends approximately the same length as a fully constructed bicycle. Moreover, due to the L-shape frame design, such frame is incapable of being packaged and shipped in a space-efficient manner. As such, when shipped in its fully constructed state, the finished products can have dramatically higher shipping costs than they would otherwise have if they could be packaged in a much smaller, space efficient configuration.

While it is recognized that space efficiency during shipment is one major concern, competing issues arise with respect to the ability to assemble the product for use by consumers. It will be readily appreciated that fabricating the frames of the hybrid bicycle/skateboard products may be accomplished in a variety of ways; however, significant difficulties arise to the extent such assembly becomes too complicated insofar as consumers, who are often times required to assemble the product, will become discouraged and be deterred from purchasing the product.

In addition to the need to design frames that are “assembler friendly” is the need for a frame that can be assembled in a manner that causes the frame, and hence the finished product, to be exceptionally durable and minimizes the potential for the frame to break or fall apart, particularly after vigorous use. In this respect, by essentially being a scooter that will primarily be utilized by adolescents, teens and young adults, such frame must be capable of withstanding extensive and repetitive forces in anticipation of the various riders that will be using such product.

As such, there is a substantial need in the art to develop a multi-component frame design to thus enable a hybrid bicycle/skateboard scooter frame, and in particular those frames produced by The Bikeboard Company, LLC, to achieve the multiple purposes of maintaining a compact configuration to conserve space during manufacture and shipping and enabling such frame to be quickly and easily assembled that further provides for a finished frame construction that is capable of withstanding rigorous forces and ensuring long product life.

### BRIEF SUMMARY OF THE INVENTION

The present invention specifically addresses and alleviates the above-identified deficiencies. In this regard, the present invention is directed to a multi-component frame for use in constructing hybrid bicycle/skateboard vehicles, and in particular those vehicles-bearing the L-shaped frame incorporated into the BIKEBOARD™ brand of such products. According to a preferred embodiment, the frame consists of at least two tubular frame components that are operative to be interconnected to one another to form the vehicle frame. According to such embodiment, there is provided a frontal frame component, which includes a head tube and down tube portion, and a rear frame component. In a preferred embodiment, the frontal and rear frame components are interconnectable to one another to define a generally L-shape. To that end, a variety of mechanisms are available by which the frame components are interconnected. In one embodiment, the frontal frame component is provided with a smaller diameter tube extending from the rear-most portion thereof that is operative to be received within and interconnect the forward-most portion of the rear frame component. To that end, it is contemplated that such smaller tube portion may be comprised of either a section of smaller diameter tube or may simply comprise a crimped portion of the frontal frame component wherein the crimp portion creates a smaller diameter for a segment of such frame section, which is then capable of being telescopically received in a larger tubular section of the rear frame component. Separate from or in addition to the interconnection between the tube within tube embodiment are means for securing such frame component sections to one another, which may be accomplished by interconnecting a skateboard deck to the frame components wherein a portion of the skateboard deck is fastened to both the rear frame component and the frontal frame component.

In alternative embodiments, the multi-component frame will be comprised of three components, namely a frontal component, an intermediate component, and a rear component. According to such embodiment, the frontal frame component will comprise a head tube with a section of the down tube extending therefrom, the intermediate portion will include a section of down tube operative to interconnect with a portion of the down tube of the frontal frame component and a rearwardly extending portion operative to interconnect with the rear frame component per the attachment mechanisms discussed above. Specifically, the intermediate and rear frame components may interconnect with one another via a telescope-type arrangement and secured to one another via screws or bolts and the like, and/or by mounting the skateboard deck upon the intermediate and rear frame components and securing the skateboard deck respectively thereto while the intermediate and rear frame components remain interconnected. In a preferred embodiment, the portion of the interconnected frame extending below the skateboard deck may be flattened and/or provided with a plastic block or the like to define a “grinding” surface to thus enable the vehicle, when fully assembled, to make skateboard grinding maneuvers.

In another aspect of the present invention, there is provided a mechanism by which skateboard wheels are affixed to the hybrid bicycle/skateboard vehicle via attachment directly to the vehicle frame. In the first of such embodiments, the rear-most portion of the vehicle frame is provided with a flattened portion, which may take the form of an angled bend such that the tubular frame portion assumes a flattened, downwardly angled configuration. One or more apertures formed in such flattened portion serve as means for interconnecting a pair of conventional skateboard wheels. Advantageously, such frame design allows for the rapid attachment of skateboard wheels without requiring that the same be separately attached to the skateboard deck that is ultimately mounted upon the frame.

In a second embodiment, a rear-most portion of the vehicle frame is provided with a contoured surface with apertures that are operative to interconnect with conventional skateboard wheels. In this respect, the frame defines a mounting means that enables a pair of conventional skateboard wheels to be mounted directly upon the frame in a rapid manner, as opposed to being separately attached to the skateboard deck.

In a further embodiment of the present invention, it is contemplated that the frame may be provided with one or more selectively locking joints to thus enable the frame to assume operative and collapsed configurations. In this regard, it is contemplated that the interlocking joint may be formed at the juncture between the down tube and rearwardly extending frame portion of the hybrid bicycle/skateboard frame such that the down tube and rear frame portions can collapse upon one another.

### BRIEF DESCRIPTION OF THE DRAWINGS

These as well as other features of the present invention will become more apparent upon reference to the drawings.

FIG. 1 is an elevated perspective view of a hybrid bicycle/skateboard vehicle illustrating a multi-component frame design, the latter being constructed in accordance with a preferred embodiment of the present invention.

FIG. 2 is a side-view of the hybrid bicycle/skateboard vehicle depicted in FIG. 1, the latter depicting a preferred skateboard truck attachment embodiment.

FIG. 3 is an exploded side view of the hybrid bicycle/skateboard vehicle depicted in FIGS. 1 and 2.

FIG. 4 is an expanded, inverse perspective view of the end-most frame portion depicted in FIG. 3 with a skateboard truck attachment bolt as shown aligned with an aperture formed thereon.

FIG. 5 is a perspective view of FIG. 4 with the attachment mechanism shown positioned within an aperture of the end-most frame portion.

FIG. 6 is an elevated perspective view of a hybrid bicycle/skateboard vehicle illustrating a multi-component frame design, the latter being constructed in accordance with a second preferred embodiment of the present invention.

FIG. 7 is a side-view of the hybrid bicycle/skateboard vehicle depicted in FIG. 5, the latter depicting a preferred skateboard truck attachment mechanism in accordance with a second preferred embodiment.

FIG. 8 is a side exploded view of the preferred embodiment of the hybrid bicycle/skateboard vehicle depicted in FIGS. 5 and 6.

FIG. 9 is a expanded, inverse perspective view of the end-most portion of the frame depicted in FIG. 8 for use in attaching skateboard wheels.

FIG. 10 is a perspective view of a hybrid bicycle/skateboard frame constructed in accordance with a preferred embodiment of the present invention.

FIG. 11 is a side view of a selectively collapsible joint for use in connection with the frame depicted in FIG. 10.

FIG. 12 is a cross-sectional and top view of tubing formed to have a smaller diameter for use in interconnecting the frame portions utilized in constructing the hybrid bicycle/skateboard of the present invention.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

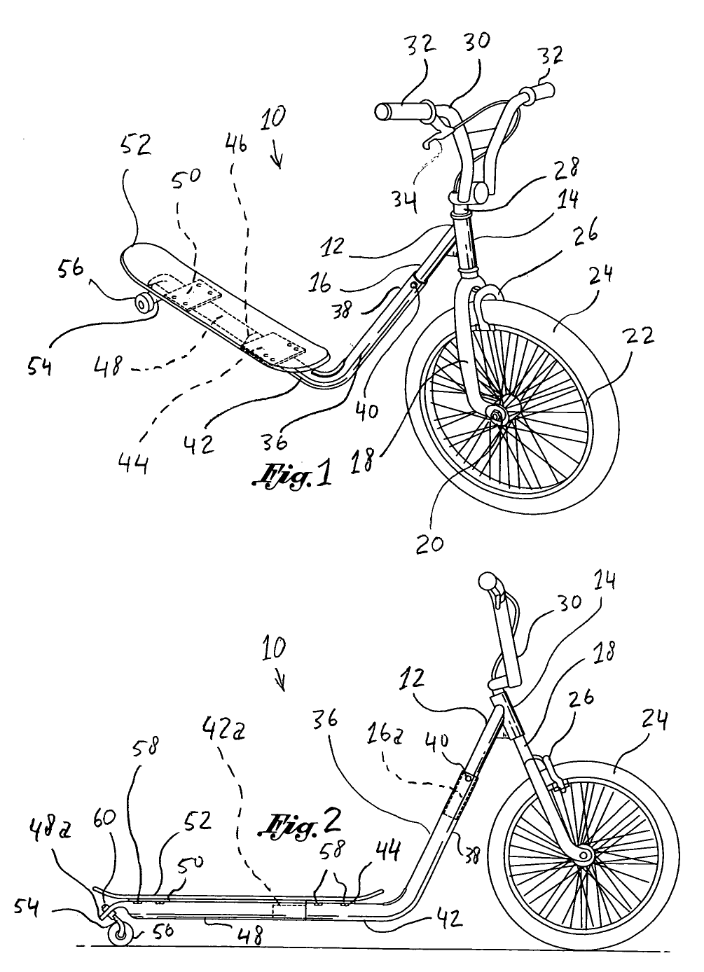

Referring now to the Figures, and initially to FIG. 1, there is perspectively illustrated a hybrid bicycle/skateboard vehicle 10 utilizing a multi-component frame design, the latter constructed in accordance with a preferred embodiment of the present invention. In this regard, the multi-component frame design utilized to construct the vehicle 10 of the present invention is sought to represent novel and non-obvious structure for facilitating the shipment and construction of the hybrid bicycle/skateboard vehicles that are the subject of pending U.S. Design patent application Ser. No. 29/205,028, filed May 7, 2004 entitled FRAME DESIGN and U.S. Ser. No. 29/208,130, filed Jun. 24, 2004 entitled FRAME DESIGN, the teachings of which are incorporated herein by reference.

To that end, the frame of the vehicle 10 of the present invention is essentially comprised of three components, namely, a front frame component 12, and intermediate frame component 36, and a rear frame component 48. With respect to the former, frontal frame component 12 includes a head tube portion 14 that is operative to function per conventional head tube sections of a conventional bicycle frame. In this regard, the head tube 14 is operative to receive and interconnect stem 28 and handlebars 30, which may comprise conventional bicycle handlebars with handlebar grips 32 and hand brake 34, via stem 28 to a pair of forks 18 that extend downwardly from head tube 14. Attached to the forks 18, per conventional bicycle design, is hub 20 with rim 22 and tire 24 mounted thereabout. There is further provided front brake 26 that is operatively coupled to brake lever 34 to thus enable the same to be manually actuated.

Front frame component 12 further includes down tube portion 16 that is interconnected via bolt 40 to intermediate frame component 36. More specifically, the distal-portion of down tube 16 of frontal frame component may be telescoped within the upwardly-extending frame portion 38 of intermediate component 36 to form the structure as shown. In an alternative embodiment, frontal frame component 12 and intermediate frame component 36 will be formed as an integral, unitary structure that will omit the need to interconnect such pieces via bolt or coupling 40 as shown. In this respect, by combining frontal frame component 12 with intermediate frame component 36 can, in some respects, facilitate easier frame manufacture by having to fabricate fewer frame pieces.

Intermediate frame component 36 is further provided with a rearwardly extending portion 42 upon which is formed first attachment plate 44. As will be appreciated by those skilled in the art, the frame portions discussed herein will preferably be fabricated from conventional metal bicycle tubing or other materials well-known to those skilled in the art for use in fabricating bicycle frames and the like, which may include but not limited to any of a variety of graphite fiber and/or plastic materials possessing the requisite hardness and strength to function in such applications. Accordingly, it will be readily appreciated by those skilled in the art that any of a wide variety of materials can be readily utilized for use in the practice of the present invention.

The end-most portion 42 of intermediate frame materials 36 preferably abuts with rear frame component 48 at the juncture 46 as shown. In this respect, the rear portion 42 will preferably cooperate and interconnect with rear frame component tubing 48 to form a continuous tubular structure as shown. In a preferred embodiment, the bottom portion of the tubing interconnecting rear portion 42 with rear frame component tubing 48 may be flattened to define a planar surface extending along the length of such interconnected tubing or may otherwise be designed and configured to mount or interconnect with a plastic grinding bar or strip, well-known to those skilled in the art with respect to skateboard construction, to thus enable the vehicle 10 to perform grinding maneuvers as per conventional skateboard usage. Along these lines, there is further preferably provided a second attachment plate 50 that is welded or otherwise attached to rear frame portion 48 that, for reasons discussed below, will cooperate with front attachment plate 44 to provide means to affix a conventional skateboard deck 52.

To enable the vehicle 10 to move, a pair of skateboard wheels 54 are preferably affixed to the rear-most end of rear frame portion 48. In this regard, it is contemplated that such skateboard wheels 54 may be affixed via n axle or a conventional skateboard truck well-known to those skilled in the art. It is especially preferred, for reasons discussed more fully below, that the skateboard wheels be directly affixed to rear frame portion 48, as opposed to attaching a skateboard truck separately to deck 52, in order to substantially decrease the complexity and labor associated with the construction of the vehicles 10 of the present invention.

Referring now to FIG. 2, there is provided a side view of the vehicle 10 showing the various features thereof. As shown, the three frame portions, namely, frontal frame component 12, intermediate frame component 36 and rear frame component 48 cooperate to define a generally L-shape with the front portion of the frame via head tube 14 being operative to receivably hold and interconnect handlebars 30 with forks 18, the latter interconnecting with front wheel and tire 24 and brakes 26. Advantageously, such features enable the vehicle 10 of the present invention to be steerable in nature, unlike conventional skateboards that require the rider to lean and shift his or her weight while maintaining his or her balance on the moving skateboard. Such feature dramatically simplifies the use of the vehicles 10 of the present invention, as well as dramatically increases the safety associated with use of such vehicles, especially by smaller children.

Further illustrated is the interconnection between frontal frame component 12 and intermediate portion 36 via the section of down tube 16a extending telescopically within down tube portion 38 of intermediate component 36. As discussed above, in certain embodiments it is preferred that the frontal frame component 12 will be integrally formed with intermediate frame portion 36 to thus form a unitary structure. In addition, to the extent frontal frame component 12 and intermediate frame component 36 are formed as separate components, as shown, it will be readily appreciated by those skilled in the art that a wide variety of means are available by which the two can be interconnected together than the manner shown. In this respect, it will be well-understood that frame portion 38 may be sized and configured to be received within frame portion 16 of frontal frame portion 12. It is likewise contemplated that frame portions 16 and 38 can be interconnected via bolts, locking pins, quick-release mechanisms intermediate bracing structures, reciprocal locking devices, and any of a variety of mechanisms well-known to those skilled in the art. Likewise, it is contemplated that the interconnection between frame portions 16 and 38 may be selectively adjustable such that the distance frontal frame component 12 extends from intermediate frame component 36 via the down tube connection can be selectively adjusted.

Also depicted in FIG. 2 is the interconnection between intermediate frame component 36 and rear frame component 48. As illustrated, the rear-most end 42a of intermediate frame component 36 is provided with a telescoping tubular segment that is operative to be received within rear frame component 48. To that end, it is contemplated that tubular portion 42a may be defined by a smaller diameter tube extending from the rearwardly extending portion 42 of intermediate frame component 36. Alternatively, it will be understood that rear frame component 48 may likewise be provided with a smaller diameter tube or similar structure capable of being received within tubular section 42 of intermediate frame component 36 to thus enable the respective frame components 36, 48 to be interconnected with one another.

In one preferred embodiment depicted in FIG. 12, such smaller diameter tubular structure may be formed simply by forming at lease one and preferably two elongate crimp at the rear-most end 42a of rearwardly extending frame portion 42. As illustrated, bends or crimps 45 and 47 are formed at opposed ends of tubular structure 42 to thus cause the distance represented by the “D” to decrease in size relative the non-bent portions of frame 42. By forming such bends 45, 47 in the manner shown, the smaller diameter structure 42a will be formed at the rear-most end of frame portion 42 as illustrated by the side view also provided as part of FIG. 12.

As will be readily appreciated, once such smaller diameter tubular structure is formed, the same will easily be able to be telescoped within rear frame component 48 in the manner shown. Once received therein, the two frame components 36, 48 may be affixed to one another by any of a wide variety of mechanical means known in the art, including but not limited to bolts, locks, registry pins or any other means discussed herein and well-understood by those skilled in the art. Along these lines, and in other embodiments of the invention shown, it is further contemplated that the interconnection between intermediate frame component 36 and rear frame component 48 may be accomplished not by interlocking rear-most frame portion 42a within rear frame portion 48, as shown, but by the affixation of the skateboard deck 52 upon such frame as shown. As discussed above, the frame of the vehicle 10 of the present invention will preferably be provided with a first attachment plate 44 and second attachment plate 50 that are operative to cooperate with one another to affix the conventional skateboard deck 52 as shown. To help facilitate that end, skateboard deck 52 may be provided with attachment mechanisms to more easily and readily connect with the attachment plates 44, 50.

As illustrated, the first plate 44 will be formed upon tubular portion 42 of intermediate frame component 36 and the second connection plate 50 being formed upon rear frame component 48. Such attachment plates 44, 50 will be provided with apertures through which screws 58 may be utilized to interconnect with the skateboard deck 52 in the manner shown in FIG. 2. In this regard, by merely interconnecting intermediate and rear frame component 36, 40 to one another in the manner shown thus enables the skateboard deck 52 to not only be affixed to first and second mounting plates 44, 50 but also enable the skateboard deck 52 to serve as the means for maintaining the rigid interconnection between intermediate and rear frame components 36, 48.

Along these lines, in further refinements of the invention it is contemplated that intermediate and rear frame components 36, 48 may be rigidly interconnected with one another such that the bottom-most sections of tubing (i.e., the tubing closest to the ground) may be formed to have a flattened configuration or else otherwise adapted to receive and interconnect with an elongate plastic strip, bar or the like to thus enable the lower portion of the interconnected frame to make grinding maneuvers well-known in the field of skateboarding. In this respect, because tubular frame components 36, 38 will possess a generally cylindrical shape, in certain applications it will be necessary to modify the same either by flattening or providing a grinding type member or both. By providing such grinding structure will thus enable the rider of the vehicle 10 of the present invention to not only perform grinding maneuvers, but also be able to do so in a manner that minimizes potential damage to the vehicle and frame structure.

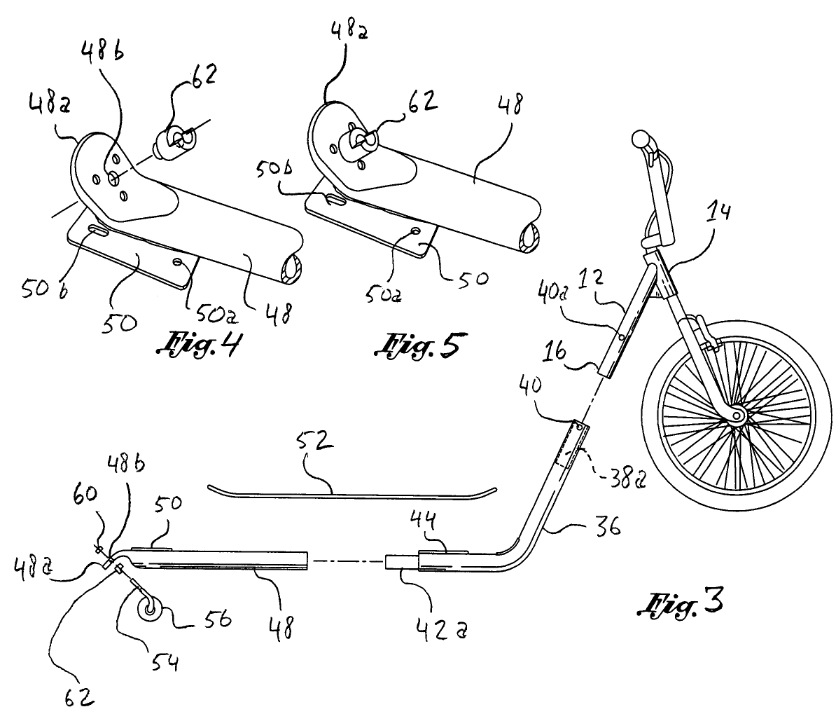

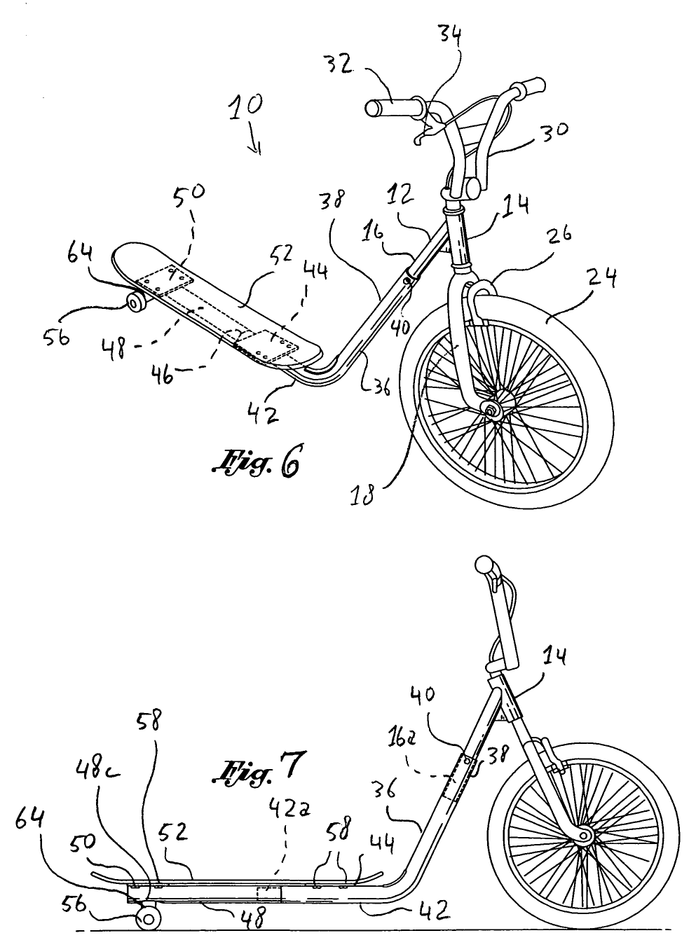

As further illustrated in FIG. 2, and more clearly seen in FIGS. 3-5, a conventional skateboard wheel 56 is further connected to the vehicle, preferably at the end-most portion 48a or rear frame portion 48. In this regard, and as more clearly seen in the exploded view of FIG. 3, rear frame portion 48 will preferably be provided with a flattened portion of frame tubing, which in the embodiment shown has a bend or downwardly angled portion 48a that serves as a rigid structure to which the skateboard wheel 54, via its attachment to conventional skateboard truck may be affixed. To that end, and as more clearly illustrated in FIGS. 4 and 5, which depict an inverted view of the end-most portion 48a of frame portion 48, the downwardly angled bend 48a provides a rigid structure through which an aperture 48a may be formed. Such aperture will be sized and configured, as well as appropriately angled to receive a registry nut 62, the latter of which is capable of being interconnecting and locking with bolt 60 shown in FIGS. 2 and 3, to form the structure in FIG. 5. In this regard, registry bolt 62 will be operative to interconnect with an axle or skateboard truck 54 to thus enable the same to maintain the skateboard wheels 56 in a rigid orientation relative to the ground, as illustrated in FIG. 2. Along these lines, although discussed in terms of a conventional skateboard wheel and truck assembly, it will be well understood by those skilled in the art that a wide variety of attachment mechanisms may be deployed via the flattened rear-most portion 48a of rear frame component 48 to thus enable a pair of skateboard wheels 56 to be securely fastened thereto. Accordingly, although shown as being interconnected through an aperture extending through an angled frame portion 48b, it will be understood that such frame portion 48b may be manipulated in a variety of shapes and configurations that can enable a pair of skateboard wheels or the like to be securely fastened thereto.

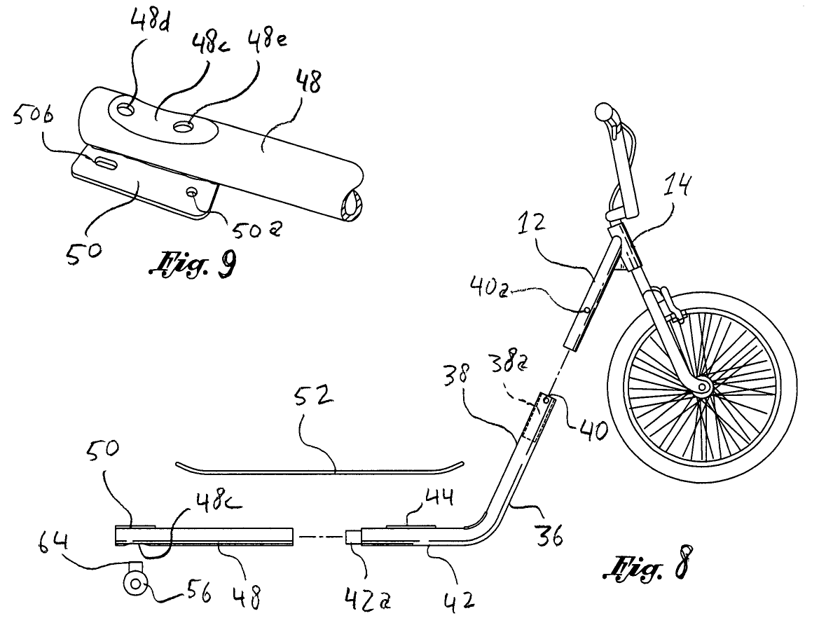

Referring now to FIGS. 6-9, and initially to FIG. 6, there is shown a slightly modified embodiment of the vehicle 10 of the present invention. Per the embodiment discussed above, the vehicle 10 will be formed from a multi-component frame, which as depicted comprises frontal frame component 12, intermediate frame component 36 and rear frame component 48. Also, per the embodiment discussed above, it should be understood that frontal frame component 12 and intermediate frame component 36 may be integrally formed to one another such that the same do not have the interconnection between tubular sections 16, 38 that are interconnected via bolt 40 as shown. In most other aspects, the embodiment depicted in FIGS. 6-8 will substantially correspond to the structure described above, and will include the use of conventional handlebars, bicycle forks and front bicycle tire with hand brake mechanism, as well as the conventional skateboard deck 52 affixed to attachment plates 44 and 50 formed upon rear frame section 42 of intermediate component 36 and rear frame component 48, respectively. Also, the interconnection between frame component 12, 36 and 48 will be the same as outlined above, and may make use of telescoping tubular portions, such as 16a disposed within tubular section 38 of intermediate frame component 36 and 42a disposed within rear frame component 48, as shown is FIG. 7. As discussed above, such tubular portions may be interconnected to one another via any well-recognized means in the art, such as through bolts, locking pins and the like. Additionally, with respect to the interconnection between intermediate frame component 36 and rear frame component 38, the same may be accomplished merely by interconnecting skateboard deck 52 to the first and second attachment plates 44, 50 via bolts 58, such that the skateboard deck secures intermediate frame component 36 to rear frame component 48, and more particularly, enables tubular section 42a to become actually disposed within rear frame component 48. Likewise, intermediate frame component 36 may interconnect to rear frame component 48 in a manner that defines a flattened section of tubing or is otherwise adapted to receive a grinding bar or member capable of being affixed thereto to thus enable the vehicle 10 to perform grinding maneuvers.

The one aspect of the embodiment depicted in FIGS. 6-9 varies from that embodiment depicted in FIGS. 1-5 is the mechanism by which the skateboard wheels 56 are affixed to the vehicle. As more clearly seen in FIGS. 7-9, the skateboard wheels 56 are affixed to the vehicle by being directly mounted upon rear frame component 48 at the specified section point 48c formed thereon. In this regard, rear frame component 48 will include a flattened portion having apertures formed therein, discussed more fully below in connection with FIG. 9, that enables a skateboard truck 64 to be directly affixed thereto. In this respect, and as will be readily appreciated by those skilled in the art, such skateboard truck 64 may be configured to bolt directly to the frame tubing 48, which thus eliminates the need for such skateboard truck 64 to be separately attached to the skateboard deck 50, as is required per the manufacture of conventional skateboards.

To achieve that end, there is shown in FIG. 9 an inverted view of the rear-most portion of rear frame component 48 which depicts section 48c to which the skateboard truck 64 is affixed. As illustrated, section 48c is provided with a flattened, contoured surface operative to interconnect with skateboard truck 64. As is well-known to those skilled in the art, most conventional skateboard trucks are configured to be affixed to a flat surface, namely, the rear portion of a skateboard deck, and cannot readily be bolted or otherwise secured to a curved surface, such as conventional bicycle tubing. In addition, such flattened portion 48c will be provided with one or more apertures 48d, 48e to provide means through which conventional bolts may be secured. As will be readily understood, such frame portions 48c and apertures 48d, 48e may be readily fabricated through well-known techniques in the metal fabrication arts, and may comprise simple processes such as flattening or boring.

Once so formed, skateboard truck 64 can be directly mounted upon such rear frame component 48 in a manner that is substantially easier, reliable and time efficient. In this regard, providing such attachment means to secure the axle or skateboard truck 64 with skateboard wheels 56 affixed thereto eliminates the need to directly mount such skateboard truck to the rear portion of the skateboard deck 52 via a separate step. Additionally, by readily identifying the point at which the skateboard truck 64 will be attached eliminates the need to estimate or otherwise determine skateboard truck 64 placement.

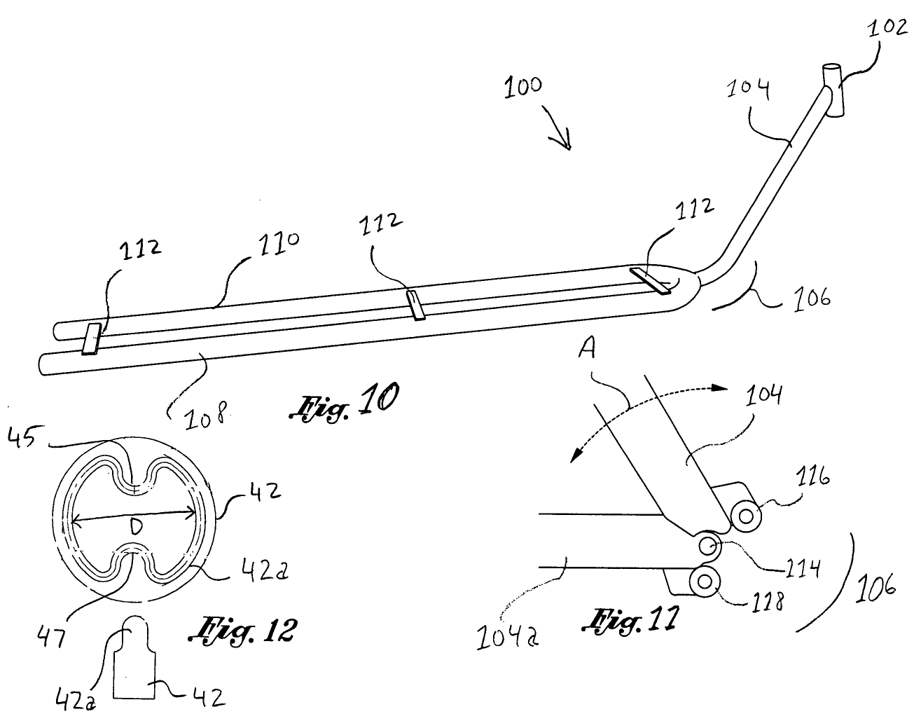

Referring now to FIGS. 10 and 11, and initially to FIG. 10, there is further depicted a multi-component frame design consistent with the principles of the present invention. As illustrated, such frame 100 defines a generally L-shape via the combination of head tube 102, down tube 104 and elongate frame sections 108 and 110, the latter extending in general parallel relation to one another as shown. In this regard, down tube portion transitions to elongate frame portions 108, 110 via a bend or joint 106 as shown. In order to provide structural rigidity to the frame, cross members 112 may be provided between parallel-extending members 108, 110. Such cross members may be secured via welding and/or other techniques known in the art.

In contrast to the above embodiments, the frame 100 depicted in FIG. 10 may preferably be provided with a collapsible joint mechanism as shown in FIG. 11. In this respect, at some point along the length of down tube 104, and preferably around transition section or bend 106, a pivot 114 is introduced to thus enable top frame portion 104a to rotate in the manner indicated by the letter “A” relative remaining frame portion 104. The pivoting joint 114 may further be provided with a locking mechanism 116 that complements connecting section 118 to thus enable the frame portions 104, 104a to interlock with one another to form a rigid frame structure, such as the structure depicted in FIG. 10. Such selectively lockable joint mechanism, defined by components 114, 116 and 118 may be designed via a variety of configurations well-known to those skilled in the art. In this respect, it is contemplated that such selectively lockable joint mechanism will closely mimic similar locking mechanisms incorporated in a variety of conventional scooters, such as the RAZOR™ brand of scooters imported by Razor USA, LLC. Additional variations will also be readily apparent to those skilled in the art.

Additional modifications and improvements of the present invention may also be apparent to those of ordinary skill in the art. For example, while shown forming generally L-shaped frames, the multi-component frame of the present invention can be designed to form a wide variety of dissimilar shapes, such as “2” shaped or “Z” shaped frames. Thus, the particular combination of parts and steps described and illustrated herein is intended to represent. only certain embodiments of the present invention, and is not intended to serve as limitations of alternative devices and methods within the spirit and scope of the invention.

1. A multi-component frame of a hybrid bicycle/skateboard vehicle comprising:
a. a first frame component; and
b. a second frame component interconnectable with said first frame portion, said first and second frame portions being interconnectable with one another to define a frame having a head tube, a down tube portion, and means for interconnecting with a skateboard deck.

2. The multi-component frame of claim 1 wherein said head tube defined by said interconnected frame components is operative to receive and interconnect a set of bicycle handlebars with stem with a conventional bicycle fork.

3. The multi-component frame of claim 1 wherein a respective one of said frame components further defines means for attaching a pair of skateboard wheels thereto.

4. The multi-component frame of claim 3 wherein said means for attaching said skateboard wheels comprises a section of bent tubing having an aperture formed therethrough, said aperture being sized and configured to define means for secureably attaching a skateboard truck.

5. The multi-component frame of claim 3 wherein said means for attaching said skateboard wheels comprises a flattened section of tubing having at least one aperture formed therein, said aperture being sized and configured to define means for secureably attaching a pair of skateboard wheels.

6. The multi-component frame of claim 5 wherein said section of said flattened section is provided with at least two apertures, said at least two apertures being operative to define means for interconnecting with an axle supporting said pair of skateboard wheels.

7. The multi-component frame of claim 1 wherein said interconnected first and second frame components are operative to define a generally L-shape.

8. The multi-component frame of claim 1 wherein said first and second frame components are formed from metallic bicycle tubing.

9. The multi-component frame of claim 1 wherein said means for interconnecting with said conventional skateboard deck comprises at least one attachment plate formed upon a respective one of said frame members, said at least one attachment plate having at least one aperture defining means for attaching said skateboard deck to said attachment plate.

10. The multi-component frame of claim 9 wherein said attachment plate is provided with at least two apertures through which bolts or screws can be inserted to interconnect said skateboard deck to said attachment plate.

11. The multi-component frame of claim 9 wherein said means include at least two attachment plates each having dedicated apertures formed thereon for securing said skateboard deck thereto.

12. The multi-component frame of claim 11 wherein a respective one of said attachment plates is formed upon said first frame component and the respective other attachment plate is formed upon the second other frame component.

13. The multi-component frame of claim 1 wherein a respective one of said frame components includes a frame portion operative to be received within the respective other frame component.

14. The multi-component frame of claim 13 wherein said frame portion of said respective one of said frame components is telescopically received within said respective other frame component.

15. The multi-component frame of claim 14 wherein said frame portion comprises a reduced diameter section of tubing operative to be received within said respective other frame component.

16. The multi-component frame of claim 15 wherein said section of tubing having a reduced diameter is formed by at least one elongate a crimp along said portion of tubing having said reduced diameter.

17. The multi-component frame of claim 16 wherein said tubing has two diametrically opposed crimps formed thereon.

18. A multi-component frame for a hybrid bicycle/skateboard vehicle comprising:
a. a first frame component defining a head tube and a segment of down tube;
b. an intermediate frame component comprising a section of down tube operatively interconnectable with said section of said down tube of said front frame component, a bend, and a secondary portion;
c. a rear frame component operatively interconnectable with said secondary portion of said intermediate frame component; and
d. wherein said front frame component, intermediate frame component, and rear frame component are interconnectable to define a generally L-shape.

19. The multi-component frame of claim 18 wherein said down tube portion of said front frame component is integrally formed with said down tube portion of said intermediate frame component.

20. The multi-component frame of claim 18 wherein said head tube portion of said front frame component is operative to receive and interconnect a set of bicycle handlebars and bicycle fork.

21. The multi-component frame of claim 18 wherein said secondary portion of said intermediate frame component includes a first attachment plate formed thereon and said rear frame component includes a second attachment plate formed thereon, said first and second attachment plates defining means to affix a conventional skateboard deck to said intermediate and rear frame components when said intermediate and rear frame components are interconnected to one another.

22. The multi-component frame of claim 18 wherein said rear frame component is adapted to interconnect with a pair of skateboard wheels.

23. The multi-component frame of claim 18 wherein said secondary portion of said intermediate frame component includes a section of tubing having a reduced diameter that is operative to be received within a portion of said rear frame component.

24. The multi-component frame of claim 23 wherein said section of tubing formed upon said secondary portion of said intermediate frame component is formed by forming at least one crimp length-wise upon-said tubing.

25. The multi-component frame of claim 24 wherein at least two crimps are formed along said section of said secondary tubing to form said tubing having said reduced diameter.

26. The multi-component frame of claim 18 wherein said frame components are formed from metallic bicycle tubing.

27. A collapsible frame for a hybrid bicycle/scooter vehicle comprising:
a. a first frame portion defining a head tube and a down tube;
b. a second frame component extending from said first frame and defining a structure for interconnecting with a conventional skateboard deck; and
c. a lockable joint formed intermediate said first and second frame portions that is operatively transitional to enable said first and second frame members to rotate about a pivot in a first configuration and maintain said frame components in a rigid, locked position such that said first and second frame components define a generally L-shape, when in a second configuration.

28. The multi-component frame of claim 1 wherein said interconnected first and second frame portions further define a skateboard grinding structure.

29. The multi-component frame of claim 28 wherein said grinding structure comprises a flattened section of metallic tubing.

30. The multi-component frame of claim 28 wherein said grinding surface is defined by a plastic grinding block attachable to said interconnectable frame portions.

31. The multi-component frame of claim 18 wherein said front frame component, intermediate frame component and rear frame component are interconnectable to further define a skateboard grinding structure.

32. The multi-component frame of claim 18 wherein said grinding structure is defined by a flattened section of tubing formed upon said secondary portion of said intermediate frame component and said rear frame component.

33. The multi-component frame of claim 32 wherein the multi-frame component further comprises a plastic grinding structure attachable to said secondary portion of said intermediate frame component and a portion of said rear frame component when said front frame component, intermediate frame component, and rear frame component are interconnectable to one another.
